(19) United States
(12) Patent Application Publication
(10) Pub. No.: US 2013/0155924 A1
(43) Pub. Date: Jun. 20, 2013

(54) CODED-DOMAIN ECHO CONTROL

(71) Applicant: Rafid A. Sukkar, Niles, IL (US)

(72) Inventor: Rafid A. Sukkar, Niles, IL (US)

(73) Assignee: TELLABS OPERATIONS, INC., Naperville, IL (US)

(21) Appl. No.: 13/327,228

(22) Filed: Dec. 15, 2011

(51) Int. Cl. H04M 9/08; H04W 52/02

(52) U.S. Cl. 370/311; 379/406.06

(57) ABSTRACT

A system, apparatus, method, and computer-readable medium for coded-domain echo cancellation. The method includes receiving a signal including at least one packet, and replacing the at least one packet with a replacement packet. In one example, the replacement packet is a comfort noise packet (such as a SID_UPDATE packet) or a NO_DATA packet. In an example embodiment, the at least one packet included in the signal includes one or more comfort noise packets, and, prior to the replacing, the one or more comfort noise packet(s) are stored in a buffer. In another example, prior to the replacing, the at least one packet is compared to a reference packet to determine whether the at least one packet is an echo packet. The packet, in one example, is encoded based on an adaptive multi-rate (AMR) (e.g., AMR-NB or AMR-WB) codec.

### BACKGROUND OF THE INVENTION

1. Field of the Invention

Example aspects described herein relate to voice quality enhancement (VQE), and, in particular, to a system, apparatus, method, and computer program product for performing coded-domain echo cancellation.

2. Description of the Related Art

The term echo generally refers to a reflection of sound, arriving at a listener some time after the direct sound. In the context of telephony communications, an echo refers to a user speaking into a telephone and hearing a reproduction of their voice after some time delay. There are many possible causes of echo in a telephone voice signal. Echo can come from a handset itself, from feedback from an earpiece to a mouthpiece, e.g., in a BLUETOOTH headset, where the earpiece and mouthpiece are located relatively near each other. In some cases, the ability of handsets, BLUETOOTH devices, and/or the like to mitigate echo is limited due to power limitations and/or a limited availability of computational resources. Thus, in some cases, network operators employ network-based VQE to perform echo cancellation.

In some cases, in order to conserve bandwidth, a voice signal is divided into frames and each frame is compressed (i.e., encoded) and formed into packets by communication devices before being transmitted to a destination communication device via a telephony network. In some older generation mobile networks, the encoded voice packets are decoded (e.g., into G.711 samples) at a base transceiver station, such that the packets are in an unencoded form while propagating within a mobile core network. In these cases, network-based echo control may be performed on the unencoded data using conventional voice processing techniques. A receiving base station then re-encodes the packets and sends it to the receiving handset. This decoding and re-encoding of the packet (i.e., transcoding operation or tandem encoding operation) is often performed using a lossy codec, which results in degraded voice quality. That is, the voice quality becomes more degraded with each transcoding operation.

In newer generation mobile networks, such as 3G and 4G LTE, voice packets are propagated throughout the core network in an encoded form. That is, in these newer generation mobile networks, the voice leaves the source communication device in an encoded form (encoded according to, e.g., an adaptive multi-rate (AMR) codec (such as the AMR-Narrowband (AMR-NB) codec or the AMR-Wideband (AMR-WB) codec), an enhanced variable rate codec (such as EVRC or EVRCB), or the like) and remains encoded throughout the backhaul and core network until it reaches the destination communication device where it is decoded. These networks are sometimes called transcoder-free operation (TrFO) networks because nowhere in the network does the voice undergo a transcoding operation, thereby avoiding the speech quality degradation and additional delay that can result from transcoding or tandem encoding. In TrFO networks, decoded voice packets are not available within the network except at the endpoints. It would be useful to have a system for performing a network-based VQE function, such as echo control, directly on encoded voice packets (coded-domain VQE) in conformance with transcoder free operation.

### SUMMARY

Existing limitations associated with the foregoing, and other limitations can be overcome by a method for coded-domain echo cancellation, and by a system, apparatus, and computer program product that operates in accordance with the method.

In one example embodiment herein, the method includes receiving a signal including at least one packet, and replacing the at least one packet with a replacement packet. In one example, the replacement packet is one of a comfort noise packet (such as a SID_UPDATE packet) or a NO_DATA packet.

In another example embodiment, the at least one packet included in the signal includes one or more comfort noise packets, and, prior to the replacing, the one or more comfort noise packets are stored in a buffer.

In a further example embodiment, prior to the replacing, the at least one packet is compared to a reference packet to determine whether the at least one packet is an echo packet.

In another example embodiment, prior to the replacing, the replacement packet is selected from a buffer in one of a first-in-first-out (FIFO) order, a last-in-first-out (LIFO) order, or a random order.

In one example embodiment, prior to the replacing, a processor selects, based on a predetermined discontinuous transmission (DTX) strategy, one of a SID_UPDATE packet or a NO_DATA packet as the replacement packet, although in other examples, other predetermined criteria can be used.

The packet can be encoded based on an adaptive multi-rate (AMR) codec (e.g., AMR-NB or AMR-WB), in one example.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, wherein:

FIG. 1 illustrates an exemplary telephony system that may be used in accordance with an example embodiment of the invention.

FIG. 2 illustrates an exemplary architecture diagram of a processing system that may be used in accordance with an example embodiment of the invention.

FIG. 3 is an exemplary flow diagram that illustrates an echo cancellation procedure that may be used in accordance with an example embodiment of the invention.

FIG. 4 illustrates an exemplary buffer that may be used in accordance with an example embodiment of the invention.

FIG. 5 illustrates a graphical representation of echo packet cancellation in accordance with an example embodiment of the invention.

FIG. 6 is a logical diagram of a circuit device that may be used in accordance with an embodiment of the invention.

### DETAILED DESCRIPTION

Example aspects described herein relate to voice quality enhancement (VQE), and, in particular, to a system, apparatus, method, and computer program product for performing coded-domain echo control.

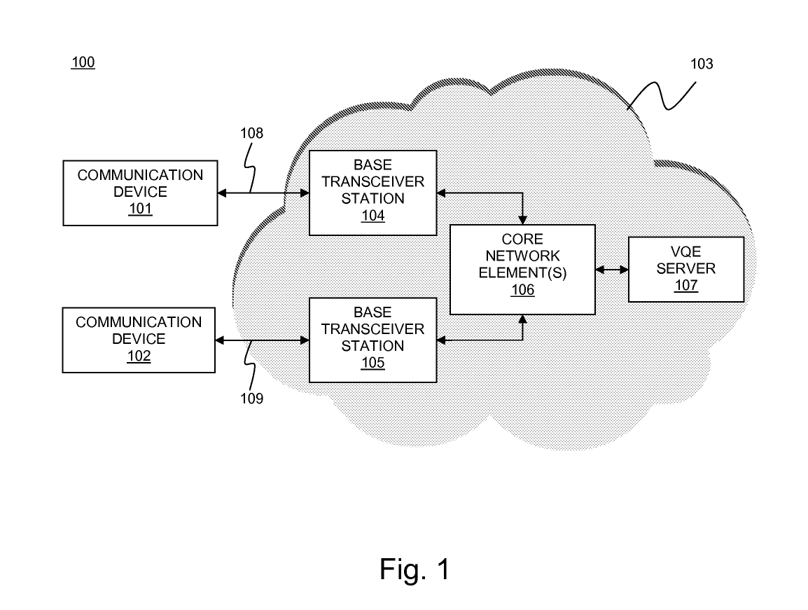

FIG. 1 illustrates an exemplary mobile telephony system 100. System 100 includes user communication device 101 and user communication device 102, each of which, in one example, is a mobile telephone or any suitable type of other communication device capable of audio communication. Communication devices 101 and 102 are communicatively coupled to a telephony network 103. In one example, the communication devices 101 and 102 are communicatively coupled to base transceiver station 104 and base transceiver station 105, respectively, via corresponding communication interfaces 108 and 109. Communication interfaces 108 and 109 can each be a wireline interface, a wireless interface, and/or a combination of a wireline interface and a wireless interface.

In the example of FIG. 1, telephony network 103 is a mobile telephony network, although this example should not be construed as limiting. In one example embodiment, any suitable type of packet-based telephony network, such as a Voice over Internet Protocol (VoIP) network, may be employed as telephony network 103.

Additionally, in other embodiments, any device suitable for facilitating communication between a communication device (e.g., communication device 101 and/or 102) and a telephony network (e.g., telephony network 103) can be employed in place of base transceiver station 104 and/or base transceiver station 105. For example, in some embodiments base station 104 and/or base station 105 can be replaced with a Node-B (e.g., in a Code Division Multiple Access (CDMA) network), an eNode-B (e.g., in a Long Term Evolution (LTE) network), and/or the like, although these examples should not be construed as limiting.

Base transceiver station 104 and base transceiver station 105 are communicatively coupled to one or more core network element(s) 106. In one example, element(s) 106 provide various services (e.g., user authentication, call control/switching, gateway access to other networks, and the like) with respect to communication devices connected to and/or within the network 103. Example core network elements 106 include a mobile switching center (MSC) (e.g., in a 3G network) and a gateway (e.g., in an LTE network), although these examples should not be construed as limiting.

The one or more core network element(s) 106 are communicatively coupled to a voice quality enhancement (VQE) server 107, which, as discussed in further detail below, is configured to perform various VQE functions, such as, e.g., echo control, on packets communicated between communication device 101 and communication device 102.

In some example embodiments, such as embodiments including a wireline telephone network, system 100 need not include base transceiver station 104, base transceiver station 105, and/or core network elements 106. In these example embodiments, VQE server 107 is communicatively coupled to communication device 101 and communication device 102, but not necessarily via one or more of the components 104, 105, 106.

Although the description provided herein (above and below) is described in the context of a mobile-to-mobile telephone call, this example should not be construed as limiting. That is, the techniques described herein can be employed for use in any encoded voice telephony network, such as, by example only, a VOIP network, or the like.

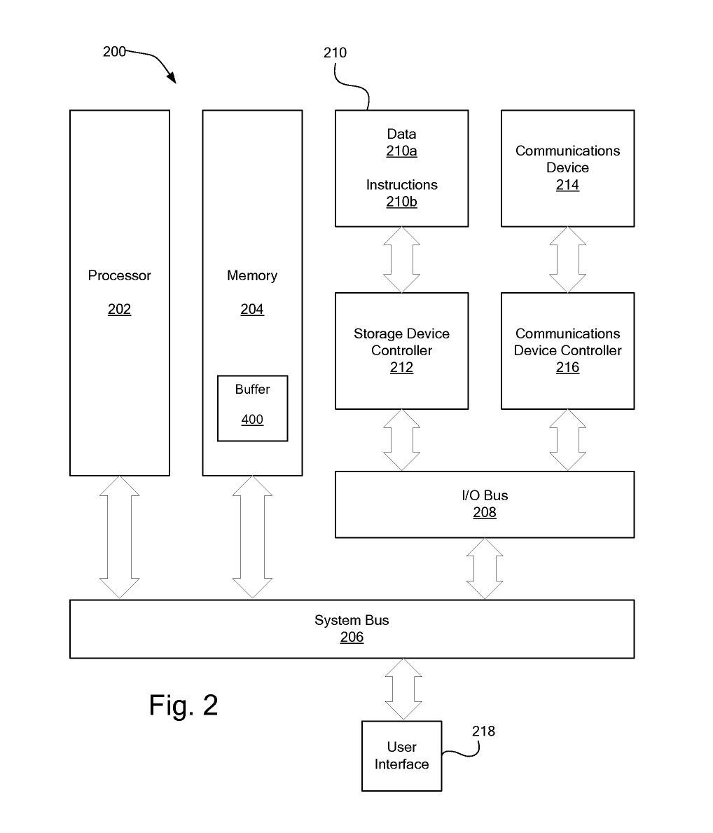

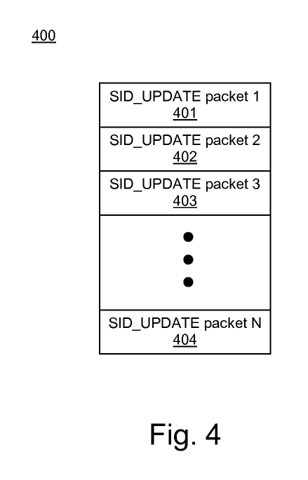

Having described exemplary telephony system 100, reference is now made to FIG. 2, which is an architecture diagram of an example data processing system 200, which in one example embodiment, can further represent VQE server 107 (FIG. 1) and/or one or more of the other components 101, 102, 104, 105, and 106 of FIG. 1, and/or one or more functional module(s) within VQE server 107 and/or such component(s). Data processing system 200 includes a processor 202 coupled to a memory 204 via system bus 206. In one example embodiment, memory 204 includes a buffer 400 (described in further detail below, with reference to FIG. 4) of comfort noise packets that are stored in the buffer 400 and/or retrieved from the buffer 400 by processor 202. Processor 202 is also coupled to external Input/Output (I/O) devices (not shown) via the system bus 206 and an I/O bus 208, and at least one input/output user interface 218. Processor 202 may be further coupled to a communications device 214 via a communications device controller 216 coupled to the I/O bus 208. Processor 202 uses the communications device 214 to communicate with other elements of a network, such as, for example, network nodes, and the device 214 may have one or more input and output ports. Processor 202 also can include an internal clock (not shown) to keep track of time, periodic time intervals, and the like.

A storage device 210 having a computer-readable medium is coupled to the processor 202 via a storage device controller 212 and the I/O bus 208 and the system bus 206. The storage device 210 is used by the processor 202 and controller 212 to store and read/write data 210a, as well as computer program instructions 210b used to implement the procedure(s) described below and shown in the accompanying drawing(s) herein, such as an echo cancellation procedure. In operation, processor 202 loads the program instructions 210b from the storage device 210 into the memory 204. Processor 202 then executes the loaded program instructions 210b to perform any of the example procedure(s) described below, for operating the system 200.

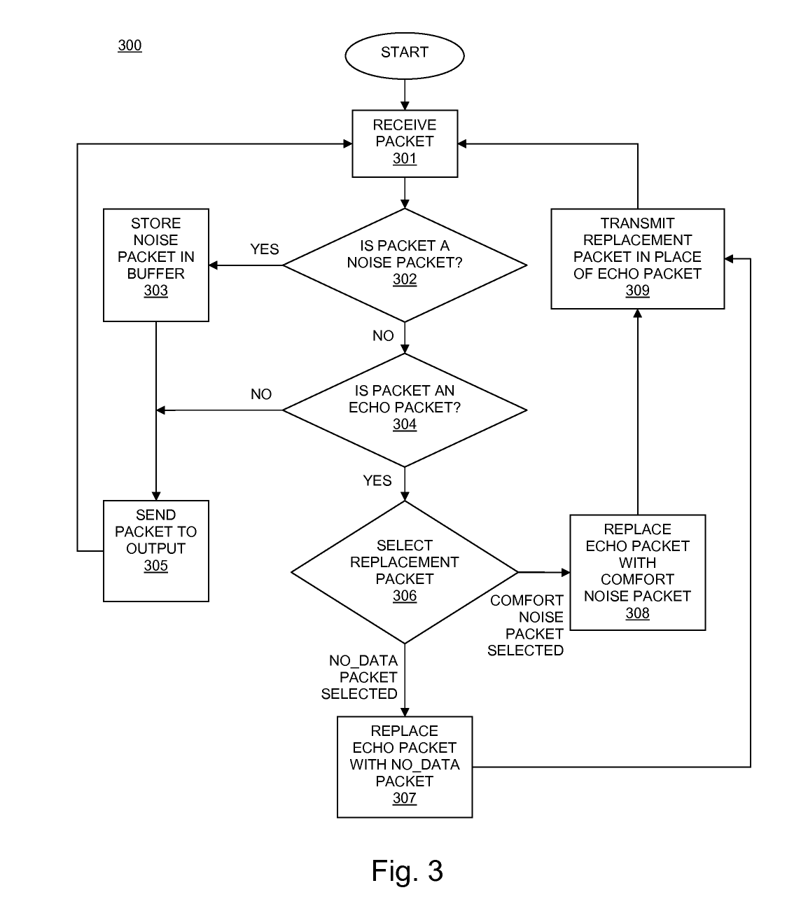

Having described data processing system 200, an exemplary echo cancellation procedure that can be implemented by one or more components of the system 100 will now be described with reference to FIG. 3. FIG. 3 is an exemplary flow diagram that illustrates an echo cancellation procedure 300 that may be used in accordance with an example embodiment of the invention. The procedure 300 of FIG. 3 will be described in the context of encoding packets in accordance with one or more versions of the Adaptive Multi-Rate (AMR) codec, such as the AMR-Narrowband (AMR-NB) codec or the AMR-Wideband (AMR-WB) codec. Versions of the AMR codec are described in, for example, the publication entitled “3GPP TS 26.090-Adaptive Multi-Rate (AMR) Speech Codec Transcoding Functions”, version 10.1.0, 3GPP Organizational Partners, September 2011, 55 pages (hereinafter “3GPP TS 26.090”); and/or the publication entitled “3GPP TS 26.190-Adaptive Multi-Rate—Wideband (AMR-WB) Speech Codec Transcoding Functions”, version 10.0.0, 3GPP Organizational Partners, March 2011, 51 pages (hereinafter “3GPP TS 26.190”). The 3GPP TS 26.090 publication and the 3GPP TS 26.190 publication are hereby incorporated by reference in their entireties, as if set forth fully herein.

Before describing in detail procedure 300, general aspects of the AMR codec will first be described. The AMR codec enables devices (such as communication device 101 and/or communication device 102) implementing the AMR codec to perform voice activity detection (VAD). VAD is the detection of the presence of audio content, such as human speech (audio content portion), or the absence of audio content (non-audio content portion) in a datastream. Some devices deactivate certain processes and/or employ discontinuous transmission (DTX) during a non-audio content portion of a datastream to avoid unnecessary coding/transmission of silence packets, to conserve computation bandwidth and/or network bandwidth. When non-audio content portions of a datastream are detected, rather than transmitting dead silence which may sound unnatural, the communication device transmits background noise packets (sometimes called comfort noise packets). In the AMR codec, comfort noise packets are transmitted in the form of SID FIRST and SID UPDATE packets, which collectively describe discontinuous transmission operation and the comfort noise, as described in, for example, the publication entitled “3GPP TS 26.092-Adaptive Multi-Rate (AMR) Speech Codec Comfort Noise Aspects”, version 10.0.0, 3GPP Organizational Partners, March 2011, 12 pages (hereinafter “3GPP TS 26.092”); the publication entitled “3GPP TS 26.192-Adaptive Multi-Rate-Wideband (AMR-WB) Speech Codec Comfort Noise Aspects”, version 10.0.0, 3GPP Organizational Partners, March 2011, 13 pages (hereinafter “3GPP TS 26.192”); the publication entitled “3GPP TS 26.093-Adaptive Multi-Rate (AMR) Speech Codec Source Controlled Rate Operation”, version 10.0.0, 3GPP Organizational Partners, March 2011, 28 pages (hereinafter “3GPP TS 26.093”); and/or the publication entitled “3GPP TS 26.201-Adaptive Multi-Rate-Wideband (AMR-WB) Speech Codec Frame Structure”, version 10.0.0, 3GPP Organizational Partners, March 2011, 23 pages (hereinafter “3GPP TS 26.201”). The 3GPP TS 26.092, 3GPP TS 26.192, 3GPP TS 26.093, and 3GPP TS 26.201 publications are hereby incorporated by reference in their entireties, as if set forth fully herein. The transmission of a SID_FIRST packet indicates that a non-audio content portion of the datastream has been detected. After a SID_FIRST packet has been transmitted by a sending communication device, one or more SID_UPDATE packets are periodically transmitted to indicate that the non-audio content portion of the datastream is still being detected, until an audio content portion of the datastream has been detected. After transmitting a SID FIRST packet, the communication device ceases sending any data (or sends NO_DATA packets) until either a predefined number of packets (or frames) have been transmitted or the characteristics of the background noise have been determined to have changed, whichever comes first. Upon either such event occurring, a SID_UPDATE packet is transmitted. Similarly, after transmitting a SID_UPDATE packet, the communication device ceases sending any data (or sends NO_DATA packets) until either a predefined number of packets (or frames) have been transmitted or the characteristics of the background noise have been determined to have changed, whichever comes first. At that point, another SID_UPDATE packet is transmitted. In response to receiving a SID_FIRST packet and/or a SID_UPDATE packet, the destination communication device generates and audibly reproduces the comfort noise described collectively by the SID_FIRST packet and SID_UPDATE packet. If at any point audio content (e.g., active speech) is detected by the sending communication device, the discontinuous transmission operation is stopped and the communication device starts transmitting audio content (e.g., speech packets).

Procedure 300 will now be described. For the sake of simplicity, procedure 300 is described below in the context of transmission of voice packets from communication device 101 to communication device 102, although of course transmission may also be provided in a reverse direction, or in both directions.

Referring back to FIG. 3, at block 301, a packet in a telephone call signal originating from communication device 101 is received by VQE server 107 via, e.g., base transceiver 104 and core network element(s) 106.

At block 302, the VQE server 107 determines whether the packet received at block 301 is a comfort noise packet (such as a SID_UPDATE packet) based on characteristics of the packet, such as, for example, information included in a header of the packet. Although procedure 300 is described herein in the context of SID_UPDATE packets, in other example embodiments, any other type of comfort noise packet can be employed instead of SID_UPDATE packets. In one embodiment, the VQE server 107 determines whether the received packet is a SID_UPDATE packet by comparing the header information of the packet to header information predetermined to correspond to SID_UPDATE packets. If the VQE server 107 determines at block 302 that the packet received at block 301 is a comfort noise packet (“yes” at block 302), then control passes to block 303.

At block 303, the packet received at block 301, which has been determined to be a comfort noise packet (e.g., a SID_UPDATE packet), is stored in a buffer (described below) of server 107 so that the packet may be subsequently used as a comfort noise packet for echo cancellation.

By using a SID_UPDATE packet (or packets) to describe the background comfort noise for echo cancellation (described below in further detail), a user of the destination communication device (which, in this example, is communication device 102) may hear background noise similar to (e.g., spectrally matched to) the background noise the user may have heard had there been no echo. Additionally, because the SID_UPDATE comfort noise packet remains encoded with the same codec as the received frame (namely the AMR codec) the network complies with the transcoder-free operation (TrFO) requirement of at least some telephony networks.

Before further aspects of procedure 300 are described, an example of a buffer that may be used in accordance with an example embodiment will now be described, with reference to FIG. 4. In one embodiment, buffer 400 is included within memory 204 as described above, and comfort noise packets (e.g., SID_UPDATE packets) are stored in buffer 400 and can be retrieved from buffer 400 by processor 202. As shown in FIG. 4, buffer 400 includes N SID_UPDATE packets, namely, SID_UPDATE packet 1 401, SID_UPDATE packet 2 402, SID_UPDATE packet 3 403, and SID_UPDATE packet N 404. The size of the buffer 400 (e.g., the number of memory locations thereof) represented in FIG. 4 is for purposes of illustration only, and the invention should not be construed as being limited only thereto.

In one example embodiment, buffer 400 is a circular buffer, or a first-in-first-out (FIFO) buffer, in which SID_UPDATE packets are received (block 301) and stored (block 303) in a circular fashion. For instance, in the example of FIG. 4, SID_UPDATE packet 1 401 is received and stored first. SID_UPDATE packet 2 402 is received and stored next. Then SID_UPDATE packet 3 403 is received and stored, and so on, until SID_UPDATE packet N is received and stored. When a new SID_UPDATE packet is received while buffer 400 is full, the oldest packet (e.g., in this example, SID_UPDATE packet 1 401) is discarded and the newly received SID_UPDATE packet (not shown) is stored in the buffer 400 in place of SID_UPDATE packet 1 401.

Referring now back to FIG. 3, after the packet received at block 301 (and determined at block 302 to be a comfort noise packet) is stored in the buffer (block 303), control passes to block 305. At block 305, the comfort noise packet received at block 301 is transmitted by the server 107, via the other components of the telephony network 103 (if any), to the call destination (which, in this example, is communication device 102). As described above, in response to receiving the comfort noise packet, the destination communication device generates and audibly reproduces the comfort noise described by the comfort noise packet. In one example embodiment, this procedure by the destination communication device can be performed in a known manner. Control then passes back to block 301 to process a next packet received by VQE server 107.

Referring back to block 302, if the VQE server 107 determines that the packet received at block 301 is not a noise packet (“no” at block 302), then control passes to block 304. At block 304, the VQE server 107 determines whether the packet received at block 301 is an echo packet, i.e., a packet containing echo. In one example embodiment, the VQE server 107 determines whether the received packet is an echo packet by comparing the received packet (which in this example originates from communication device 101) to one or more reference packet(s) (i.e., one or more packet(s) previously received from communication device 102, or otherwise a reference packet(s)). If the packet received at block 301 matches, or exhibits a predetermined level of similarity to, one of the one or more reference packet(s), then the packet received at block 301 is determined to be an echo packet at block 304. In other embodiments, any suitable type of existing or later developed algorithm for determining whether a packet is an echo packet may be employed at block 304, including (without limitation) those described in U.S. Pat. No. 8,032,365, entitled “Method and Apparatus for Controlling Echo in the Coded Domain,” filed Oct. 19, 2007, which is hereby incorporated by reference in its entirety, as if set forth fully herein.

If the VQE server 107 determines at block 304 that the packet received at block 301 is an echo packet (“yes” at block 304), then control passes to block 306. At block 306, the VQE server 107 selects a replacement packet to replace the echo packet such that when the destination communication device eventually receives the replacement packet, it generates spectrally matched comfort noise. For instance, in one example embodiment, the VQE server 107 selects and retrieves a NO_DATA packet as the replacement packet, or selects and retrieves from the buffer (e.g., buffer 400) a comfort noise packet (e.g., a SID_UPDATE packet) as the replacement packet.

In one example, the VQE server 107 determines whether to use a SID_UPDATE packet or a NO_DATA packet as the replacement packet based on predetermined DTX criteria of the AMR-NB and AMR-WB codec specification, as described in, for example, the 3GPP TS 26.092, 3GPP TS 26.192, 3GPP TS 26.093, and/or 3GPP TS 26.201 publications (mentioned above). For instance, in one example embodiment, if the packet last transmitted by the VQE server 107 to the destination communication device before the present packet is a SPEECH packet, or a NO_DATA packet where a predetermined number of consecutive NO_DATA packets have been transmitted to the destination communication device, then a SID_UPDATE packet is used as the replacement packet. On the other hand, if the packet last transmitted by the VQE server 107 to the destination communication device before the present packet is a SID_FIRST packet, or a SID_UPDATE packet, or a NO_DATA packet where the number of consecutive NO_DATA packets that have been transmitted to the destination communication device does not exceed a predetermined threshold, then a NO_DATA packet is used as the replacement packet.

SID_UPDATE packets are retrieved (block 306) from the buffer in any suitable order. For instance, in one example embodiment, SID_UPDATE packets are retrieved from the buffer in a sequential first-in-first-out (FIFO) order. In another example embodiment, SID_UPDATE packets are retrieved from the buffer in a sequential last-in-first-out (LIFO) order. In still another example embodiment, SID_UPDATE packets are retrieved (block 306) from the buffer in a random or pseudorandom order.

If at block 306 the VQE server 107 has selected a NO_DATA packet as the replacement packet, then, at block 307, the VQE server 107 replaces the echo packet with the NO_DATA packet. Control then passes to block 309 (discussed below).

On the other hand, if at block 306 the VQE server 107 has selected a comfort noise packet as the replacement packet, then, control passes to block 308, where the VQE server 107 replaces the echo packet with the particular, selected comfort noise packet. After the VQE server 107 replaces the echo packet with the comfort noise packet at block 308, control passes to block 309.

At block 309, the replacement packet employed at block 307 or 308, as the case may be, is transmitted by the VQE server 107, via the other components of the telephony network 103 (if any), to the call destination (which, in this example, is communication device 102) in place of the packet received at block 301 (and determined at block 304 to be an echo packet).

In the case where a NO_DATA packet is employed as the replacement packet (see, e.g., block 307), then upon receiving the replacement packet (i.e., the NO_DATA packet) transmitted by the VQE server 107 at block 309, the destination communication device 102 responds by audibly reproducing comfort noise based on, in one example, a previously received comfort noise packet (e.g., the SID_UPDATE packet last received by the destination communication device 102 from the VQE server 107 before the present NO_DATA packet), instead of providing echo that otherwise may have been audibly reproduced had the echo packet not been replaced.

In the case where a comfort noise packet is employed as the replacement packet (see, e.g., block 308), then upon receiving the replacement packet (e.g., a SID_UPDATE packet) transmitted by the VQE server 107 at block 309, the destination communication device 102 responds by audibly reproducing comfort noise based on the replacement packet, instead of providing echo that otherwise may have been audibly reproduced had the echo packet not been replaced. In one example embodiment, communication device 102 decodes a SID_UPDATE packet based on an AMR codec and then audibly reproduces comfort noise based on the decoded SID_UPDATE packet. In another example embodiment, communication device 102 decodes a SID_UPDATE packet or a NO_DATA packet based on an AMR codec and then audibly reproduces comfort noise based on the decoded SID_UPDATE packet and/or predetermined DTX criteria of the AMR-NB or AMR-WB codec in the case where the replacement packet is a NO_DATA packet. Control then passes back from block 309 to block 301 to process a next packet received by VQE server 107.

If the VQE server 107 determines at block 304 that the packet received at block 301 is not an echo packet (“no” at block 304), control passes to block 305. At block 305, the packet received at block 301 (and determined at block 304 not to be an echo packet) is transmitted by the server 107, via the other components of the telephony network 103 (if any), to the call destination (which, in this example, is communication device 102). By only replacing packets that are determined to include echo, and not replacing packets that are determined not to include echo, a high quality voice or other audio communication can be provided and maintained. After the VQE server 107 transmits the packet received at block 301, control passes back to block 301 to process a next packet received by VQE server 107.

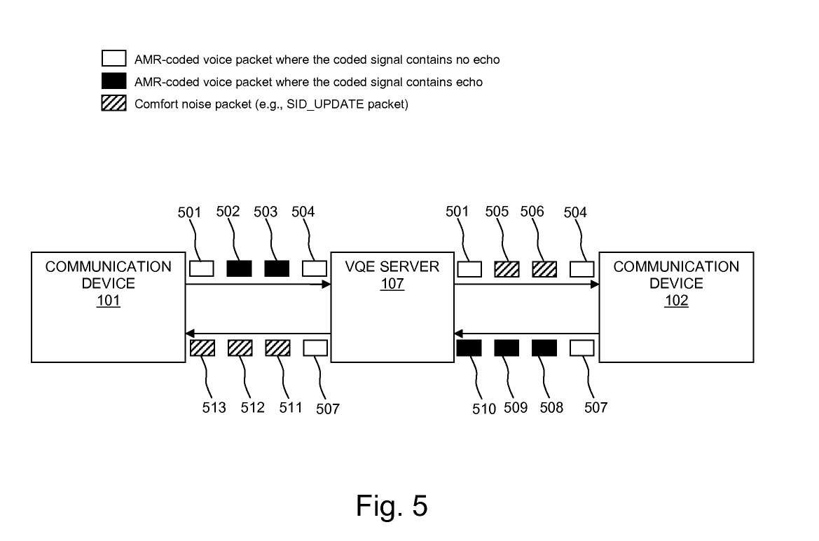

Having described two exemplary echo cancellation procedures, a graphical representation of one of the exemplary echo cancellation procedures will now be described with reference to FIG. 5. FIG. 5 illustrates a graphical representation 500 of echo packet cancellation in accordance with an example embodiment of the invention. Communication device 101 is represented as being communicatively coupled to communication device 102 via VQE server 107. VQE server 107 is configured to perform echo cancellation (e.g., in accordance with the procedure 300 described above) on packets communicated between communication device 101 and communication device 102.

Included in the datastream from communication device 101 to VQE server 107 are non-echo packets 501 and 504 and echo packets 502 and 503. VQE server 107 detects echo packets 502 and 503 and replaces them with comfort noise packets 505 and 506 (such as SID UPDATE packets previously received from communication device 101 and stored in a buffer, not shown in FIG. 5), respectively. Included in the datastream from VQE server 107 to communication device 102 are the original non-echo packets 501 and 504 and the replacement comfort noise packets 505 and 506.

Included in the datastream from communication device 102 to VQE server 107 are non-echo packet 507 and echo packets 508, 509, and 510. VQE server 107 detects the echo packets 508, 509, and 510, and replaces them with comfort noise packets 511, 512, and 513 (such as SID UPDATE packets previously received from communication device 102 and stored in a buffer, not shown in FIG. 5), respectively. Included in the datastream from VQE server 107 to communication device 101 are the original non-echo packet 507 and the replacement comfort noise packets 511, 512, and 513.

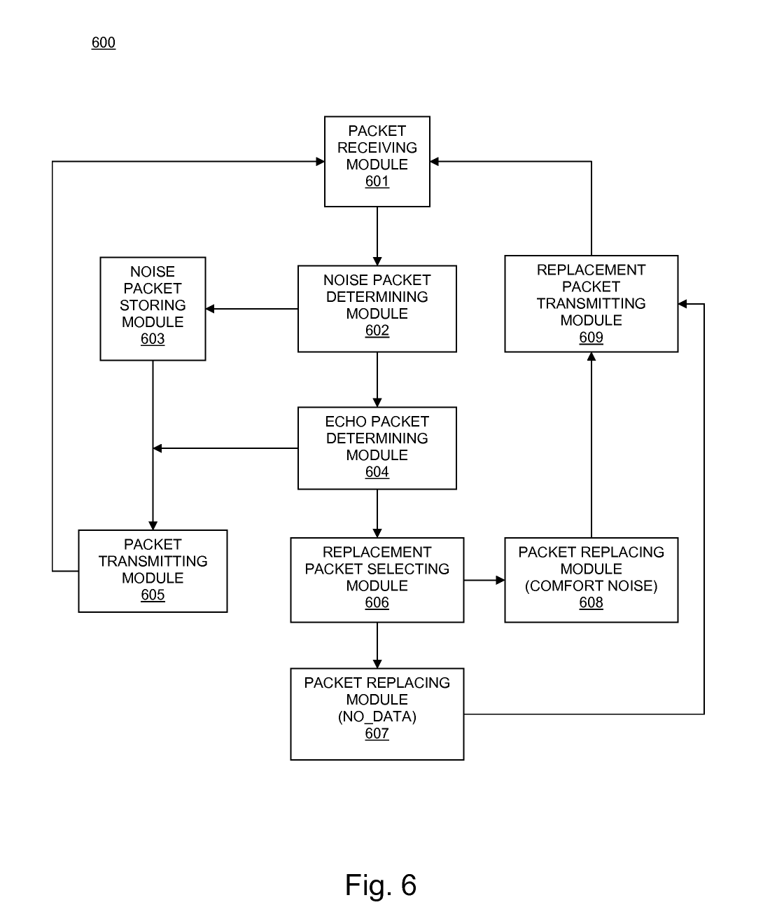

Having described a graphical representation of echo cancellation, modules of an example system for implementing an echo cancellation procedure herein will now be described with reference to FIG. 6. FIG. 6 illustrates a logical diagram of modules of an example system or similarly organized circuit device(s) (e.g., ASIC, PGA, FPGA, and the like) which could be used to form at least part of the VQE server 107 represented in FIGS. 1 and 5, and/or system 200 of FIG. 2, in accordance with example embodiments. The modules may include hardware circuitry, software, and/or combinations thereof. In an example embodiment, software routines for performing the modules depicted in logical diagram can be stored as instructions 210b in a storage device 210 and executed by processor 202 of one or more data processing systems 200 (FIG. 2). Logical diagram includes a module 601 that can perform the procedures of block 301 of FIG. 3, a module 602 that can perform the procedures of block 302 of FIG. 3, a module 603 that can perform the procedures of block 303 of FIG. 3, a module 604 that can perform the procedures of block 304 of FIG. 3, a module 605 that can perform the procedures of block 305 of FIG. 3, a module 606 that can perform the procedures of block 306 of FIG. 3, a module 607 that can perform the procedures of block 307 of FIG. 3, a module 608 that can perform the procedures of block 308 of FIG. 3, and a module 609 that can perform the procedures of block 309 of FIG. 3. In other example embodiments of the invention, the number of modules employed can differ from that depicted in FIG. 6, and one or more individual ones of the modules in FIG. 6 can perform more than one of the procedures referred to above, such that any number and combination of modules can be provided.

As can be appreciated in view of the foregoing description, even in telephony networks which require transcoder-free operation (TrFO), echo cancellation may be performed by using SID_UPDATE packets or NO_DATA packets as comfort noise packets, in accordance with example aspects of the invention.

In the foregoing description, example aspects of the invention are described with reference to specific example embodiments. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects described herein may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CDROMs, magneto-optical disks, and semiconductor devices such as FLASH memory, or other types of media/machine-readable medium suitable for storing or transmitting electronic instructions.

The techniques described herein are not limited to any particular software configuration. They may find applicability in any computing or processing environment. The terms “machine accessible medium”, “machine readable medium”, or “memory” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs. Indeed, the numbered parts of the above-identified procedures represented in the drawings may be representative of operations performed by one or more respective modules, wherein each module may include software, hardware, or a combination thereof.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures.

Although example aspects of this invention have been described in certain specific embodiments, many additional modifications and variations would be apparent to those skilled in the art. It is therefore to be understood that this invention may be practiced otherwise than as specifically described. Thus, the present example embodiments, again, should be considered in all respects as illustrative and not restrictive.

What is claimed:

1. A method for coded-domain echo cancellation, comprising:
receiving a signal including at least one packet; and
replacing the at least one packet with a replacement packet.

2. The method of claim 1, wherein the replacement packet is one of a comfort noise packet or a NO_DATA packet.

3. The method of claim 2, wherein the comfort noise packet is a SID_UPDATE packet.

4. The method of claim 1, wherein the at least one packet included in the signal includes one or more comfort noise packets, and wherein the method further comprises, prior to the replacing, storing the one or more comfort noise packets.

5. The method of claim 4, wherein at least one of the one or more comfort noise packets is a SID_UPDATE packet.

6. The method of claim 1, further comprising, prior to the replacing, determining whether the at least one packet is an echo packet.

7. The method of claim 1, further comprising, prior to the replacing, selecting the replacement packet from a buffer in one of a first-in-first-out order, a last-in-first-out order, or a random order.

8. The method of claim 1, further comprising, prior to the replacing, selecting, based on a predetermined discontinuous transmission (DTX) strategy, one of a SID_UPDATE packet or a NO_DATA packet as the replacement packet.

9. The method of claim 8, wherein the SID_UPDATE packet is selected from a buffer.

10. The method of claim 6, wherein the determining includes comparing the at least one packet to a reference packet.

11. The method of claim 1, wherein the at least one packet is encoded based on an adaptive multi-rate (AMR) codec.

12. An apparatus for coded-domain echo cancellation, comprising:
a processor configured to receive a signal including at least one packet and replace the at least one packet with a replacement packet.

13. The apparatus of claim 12, wherein the replacement packet is one of a comfort noise packet or a NO_DATA packet.

14. The apparatus of claim 13, wherein the comfort noise packet is a SID_UPDATE packet.

15. The apparatus of claim 12, further comprising a buffer, wherein the at least one packet included in the signal includes one or more comfort noise packets, and wherein the processor is further configured to store the one or more comfort noise packets in the buffer.

16. The apparatus of claim 15, wherein at least one of the one or more comfort noise packets is a SID_UPDATE packet.

17. The apparatus of claim 12, wherein the processor is further configured to determine whether the at least one packet is an echo packet.

18. The apparatus of claim 12, wherein the processor is further configured to select the replacement packet from a buffer in one of a first-in-first-out order, a last-in-first-out order, or a random order.

19. The apparatus of claim 12, wherein the processor is further configured to select, based on a predetermined discontinuous transmission (DTX) strategy, one of a SID_UPDATE packet or a NO_DATA packet as the replacement packet.

20. The apparatus of claim 19, further comprising a buffer, wherein the processor is further configured to select the SID_UPDATE packet from the buffer.

21. The apparatus of claim 17, wherein the processor is further configured to determine whether the at least one packet is an echo packet by comparing the at least one packet to a reference packet.

22. The apparatus of claim 12, wherein the at least one packet is encoded based on an adaptive multi-rate (AMR) codec.

23. A system for coded-domain echo cancellation, comprising:
a voice quality enhancement (VQE) server, the server including:
a processor configured to receive a signal including at least one packet, and replace the at least one packet with a replacement packet.

24. The system of claim 23, further comprising at least one base station arranged to communicate signals with the VQE server.

25. The system of claim 24, further comprising at least one core network element arranged to communicate signals communicated between the at least one base station and the VQE server.

26. The system of claim 25, further comprising at least one communication device arranged to communicate signals with the at least one base station.

27. The system of claim 23, wherein the replacement packet is one of a comfort noise packet or a NO_DATA packet.

28. The system of claim 27, wherein the comfort noise packet is a SID_UPDATE packet.

29. The system of claim 23, wherein the VQE server further comprises a buffer, wherein the at least one packet included in the signal includes one or more comfort noise packets, and wherein the processor is further configured to store the one or more comfort noise packets in the buffer.

30. The system of claim 29, wherein at least one of the one or more comfort noise packets is a SID_UPDATE packet.

31. The system of claim 23, wherein the processor is further configured to determine whether the at least one packet is an echo packet.

32. The system of claim 23, wherein the processor is further configured to select the replacement packet from a buffer in one of a first-in-first-out order, a last-in-first-out order, or a random order.

33. The system of claim 23, wherein the processor is further configured to select, based on a predetermined discontinuous transmission (DTX) strategy, one of a SID_UPDATE packet or a NO_DATA packet as the replacement packet.

34. The system of claim 33, wherein the VQE server further comprises a buffer, and wherein the processor is further configured to select the SID_UPDATE packet from the buffer.

35. The system of claim 31, wherein the processor is further configured to determine whether the at least one packet is an echo packet by comparing the at least one packet to a reference packet.

36. The system of claim 23, wherein the at least one packet is encoded based on an adaptive multi-rate (AMR) codec.

37. A non-transitory computer-readable medium having stored thereon sequences of instructions, the sequences of instructions including instructions, which, when executed by a processor, cause the processor to:
receive a signal including at least one packet; and
replace the at least one packet with a replacement packet.

38. The computer-readable medium of claim 37, wherein the replacement packet is one of a comfort noise packet or a NO_DATA packet.

39. The computer-readable medium of claim 38, wherein the comfort noise packet is a SID_UPDATE packet.
